(19) United States
(12) Patent Application Publication
(10) Pub. No.: US 2022/0204365 A1
(43) Pub. Date: Jun. 30, 2022

(54) Electrocoagulation Reactor for Removal of TSS, HM, COD, BOD, Color, Inorganic Organic Contaminants from a drinking water or wastewater stream

(71) Applicant: Nick Nicholas, Mooresville, NC (US)

(72) Inventor: Nick Nicholas, Mooresville, NC (US)

(21) Appl. No.: 17/247,829

(22) Filed: Dec. 24, 2020

(51) Int. Cl. C02F 1/463; C02F 1/461

(52) U.S. Cl. CPC C02F 1/463; C02F 1/46109; C02F 2201/007; C02F 2001/46171; C02F 2001/46157; C02F 2001/46152

(57) ABSTRACT

A non-chemical sustainable treatment reactor process utilizing electrochemistry for treating and reducing certain long chain inorganic and organic compounds including TSS, silica, color, BOD among other mineral compounds in drinking water, grey water and wastewater streams.

The electrocoagulation reactor chamber is built into a modular platform for ease of use and replacement of the metallic material as it used in this electrochemical process. The process is scalable for smaller and larger flow rate application when required using a continuous batch process. The reactor process includes a system controller integrating Artificial intelligence (AI) technology to optimize the system parameters and energy consumption based on the inlet water quality.

### BACKGROUND OF INVENTION

### 1. Field of Invention

This invention process is related to the field of water & wastewater treatment. More specifically, this process invention comprises the process of using a specialized electrocoagulation reactor design along with an electrical current to drastically reduce total suspended solids (TSS), heavy metals, COD, BOD. Color, and inorgaic/organic long chain compounds in a water stream.

### 2. Description of Process

There are different coagulation processes for treating water. Most of these processes uses some sort of chemical process to reduce particular contaminants from a water or wastewater treatment stream. There have been in recent years, alternative coagulation process using electricity instead of chemicals to coagulate and removal contaminants. This particular inventive process seeks to provide an added level of sophistication to the alternative coagulation process electricity instead of chemicals to coagulate and remove contaminants.

In this particular reactor process design, the utilization of both a monopolar or bipolar electrode configuration can be configured inside a square or rectangular design composed of an epoxy coated reactor skin or a polyethylene or polypropylene reactor shell. The electrodes (cathode/anode) will be composed of vertical perforated metallic plates, rings, rods or balls made of stainless steel, iron or aluminum or other specific metallic material. The thickness of the metallic material and width between metallic material will be optimized to ensure optimal power consumption and long chain compound contaminant reduction.

The treatment process through the metallic material will be an up flow process to allow a combination of upward generated gas flotation along with coagulation with coagulated overflow via top side outlet to a dissolved air flotation, incline plate clarifier or centrifugal filtration system.

The potential of air introduction into the process and the utilization of a programmable logic controller with artificial intelligence capabilities to change electrical outputs and initiate polarity reversal as necessary to reduce metallic scaling and associated process inefficiency will be integrated.

The reactor design shall be classified as a continuous batch reactor process with recirculation capabilities to ensure proper reaction time.

### 3. Brief Summary of Invention Process

The present invention process comprises a specialized process reactor for coagulating contaminants in water & wastewater treatment streams. This particular process shall be based on electrochemical in-situ reactions to significant reduce certain inorganic and organic contaminants including long chain compounds such as emulsified hydrocarbons, as well as colloidal silica, TSS, BOD, heavy metals, among other specific contaminants.

This invention process utilizes a unique modular reactor design with electrified metallic perforated plates, rods, and balls to significantly reduce colloidal contaminants in a water stream with an up flow water flow configuration to reduce fouling/plugging and maximize reactor surface area for effective treatment. This particular system can be used in new system process or it can be retrofitted into an existing system process. This system integrating this particular reactor process can be used in both pre-treatment or post treatment applications for drinking water and wastewater.

### 4. Drawing

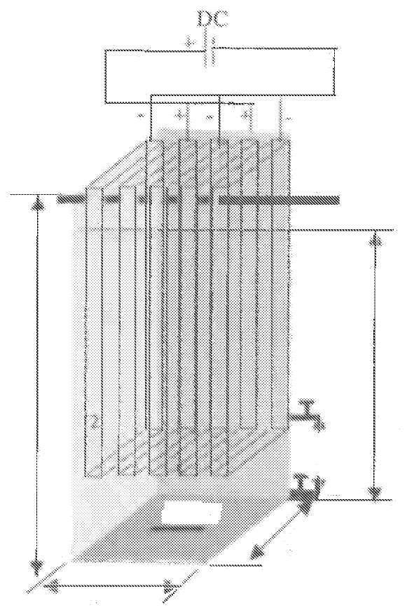

A drawing titled, FIG. 1 is provided for better understanding of the reactor design to be patented.

### 5. Detailed Description

Many contaminants in wastewater or drinking water streams, whether they be organic or inorganic in nature can be capable of being electrically removed through the use of an electrolysis process in a water source using specific metallic electrode materials.

This can be understood through chemical reactions that are created by an electrical charge created by the application of an electrical current on the surface of metallic electrode material. This electrical charge causes the release of hydrogen and oxygen in the water source, as well as an attraction of opposite charged molecules in the water source to attach to the metallic molecules of the electrode material to form coagulated suspended solids that can easily be clarified and filtered. According to FIG. 1, the source water is pumped into the modular reactor vessel, which can be of circular, square or rectangular configuration from the bottom of the reactor vessel. This source water flows through the reactor electrode material which can be composed of perforated plates, tubes, rods, irregular shapes or balls in an upward direction based on water pressure. The quantity, spacing, and size of the reactor material is based on the flow rate of the treatment system with a 1-1.5 minute hydraulic reaction time utilizing a continuous batch process.

An electrical charge is introduced by an external DC supply to the primary electrodes of the reactor design which have both positive (cathode) and negative (anode) connections.

To avoid potentially fouling/clogging of the electrode material, there is a polarity reversal capability in the system controller.

This system controller uses AI technology to optimize the chemical reactions, recirculating reaction time, and power consumption which is determined by current density and surface area of the electrode material.

The coagulated treated water flows through the system outlet and is pumped to a dissolved air flotation system or clarifier system with flocculant addition or by using a centrifugal filtration process. This would be followed by polishing tertiary filtration and disinfection steps prior to sustainable discharge, reuse or distribution.

1. The system of claim 1 utilizes a system controller with artificial intelligence (AI) that is capability of optimizing system parameters including, polarity reversal, current density, power consumption, and recirculation/hydraulic retention time to maximize the systems treatment performance.

2. The system of claim 2 has both sacrificial and non sacrificial electrodes utilizing different electrode material and shapes to maximize surface area. This configuration includes, perforated plates, rods, balls, or irregularly shaped metallic pieces.

3. The system of claim 3 wherein there is a modular capability to increase system flow capacities with the manifolding of multiple treatment systems.

4. The system of claim 4 wherein there is a positive cathode and a negative anode involved in the systems electrochemical reactions.

5. The system of claim 5, wherein the system reactor design is capable of rectangular, square or circular configuration with non reactive chamber materials of construction.

6. The system of claim 6 wherein the electrodes have a diameter in the range of 0.4 cm to 1 cm

7. The system of claim 7, wherein the electrode material can be installed vertical or horizontal in the reactor chamber based on the optimized configuration for the specific treatment application.

The system of claim 7, wherein the electrode material can be installed vertical or horizontal in the reactor chamber based on the optimized configuration for the specific treatment application.
